(19) United States
(12) Patent Application Publication
(10) Pub. No.: US 2023/0221401 A1
(43) Pub. Date: Jul. 13, 2023

(54) INTEGRITY FOR RAT DEPENDENT POSITIONING

(71) Applicant: TELEFONAKTIEBOLAGET LM ERICSSON (PUBL), Stockholm (SE)

(72) Inventors: Ritesh Shreevastav, UPPLANDS VÄSBY (SE); Sara Modarres Razavi, STOCKHOLM (SE); Iana Siomina, TÄBY (SE); Fredrik Gunnarsson, LINKÖPING (SE)

(21) Appl. No.: 17/923,373

(22) PCT Filed: May 7, 2021
(86) PCT No.: PCT/IB2021/053907

§ 371 Date: Nov. 4, 2022

Related U.S. Application Data
(60) Provisional application No. 63/021,253, filed on May 7, 2020.

(51) Int. Cl. G01S 5/02; G01S 5/00

(52) U.S. Cl. CPC G01S 5/0244; G01S 5/0027

(57) ABSTRACT

Systems and methods for generating and configuring integrity parameters associated with positioning measurements and calculations are provided herein. Integrity KPIs can be determined to assess the integrity level of a RAT-dependent positioning estimation. A network node obtains a quality of service (QoS) for a positioning application and determines an integrity key performance indicator (KPI) associated with the QoS. A wireless device receives the KPI associated with the QoS and monitors it while performing positioning measurements.

### CROSS REFERENCE TO RELATED APPLICATIONS

This application claims the benefit of U.S. Provisional Application No. 63/021,253 filed on May 7, 2020, the entire contents of which are hereby incorporated by reference.

### TECHNICAL FIELD

The present disclosure generally relates to wireless communications and wireless communication networks.

### INTRODUCTION

Standardization bodies such as Third Generation Partnership Project (3GPP) are studying potential solutions for efficient operation of wireless communication in new radio (NR) networks. The next generation mobile wireless communication system 5G/NR will support a diverse set of use cases and a diverse set of deployment scenarios. The later includes deployment at both low frequencies (e.g. 100s of MHz), similar to LTE today, and very high frequencies (e.g. mm waves in the tens of GHz). Besides the typical mobile broadband use case, NR is being developed to also support machine type communication (MTC), ultra-low latency critical communications (URLCC), side-link device-to-device (D2D) and other use cases.

Positioning and location services have been topics in LTE standardization since 3GPP Release 9. An objective was to fulfill regulatory requirements for emergency call positioning. Positioning in NR is proposed to be supported by the example architecture shown in FIG. 1. LMF 130A represents the location management function entity in NR. There are also interactions between the LMF 130A and the gNodeB 120 via the NRPPa protocol. The interactions between the gNodeB 120 and the device (UE) 110 are supported via the Radio Resource Control (RRC) protocol. Other network nodes, such as Access and Mobility Management Function (AMF) 130B and evolved Serving Mobile Location Center (e-SMLC) 130C, may be involved in positioning support.

Note 1: The gNB 120B and ng-eNB 120A may not always both be present.

Note 2: When both the gNB 120B and ng-eNB 120A are present, the NG-C interface is only present for one of them.

In the legacy LTE standards, the following techniques are supported:
Enhanced Cell ID. Essentially cell ID information to associate the device to the serving area of a serving cell, and then additional information to determine a finer granularity position.
Assisted GNSS. GNSS information retrieved by the device, supported by assistance information provided to the device from E-SMLC
OTDOA (Observed Time Difference of Arrival). The device estimates the time difference of reference signals from different base stations and sends to the E-SMLC for multilateration.
UTDOA (Uplink TDOA). The device is requested to transmit a specific waveform that is detected by multiple location measurement units (e.g. an eNB) at known positions. These measurements are forwarded to E-SMLC for multilateration.
Sensor methods such as biometric pressure sensor which provides vertical position of the device and Inertial Motion Unit (IMU) which provides displacement.

The NR positioning for Release 16, based on the 3GPP NR radio-technology, is positioned to provide added value in terms of enhanced location capabilities. The operation in low and high frequency bands (i.e. below and above 6 GHz) and utilization of massive antenna arrays provide additional degrees of freedom to substantially improve the positioning accuracy. The possibility to use wide signal bandwidth in low and especially in high bands brings new performance bounds for user location for well-known positioning techniques based on OTDOA and UTDOA, Cell-ID or E-Cell-ID etc., utilizing timing measurements to locate a UE. These methods are being standardized and planned to be enhanced in Release 17.

Until now, accuracy has been the primary positioning performance metric which has been discussed and supported in 3GPP. Emerging applications relying on high-precision positioning technology in autonomous applications (e.g. automotive) have brought with them the need for higher integrity and reliability in addition to high accuracy. The 5G service requirements specified in 3GPP TS 22.261 include the need to determine the reliability, and the uncertainty or confidence level, of the position-related data.

In RP-193237, a SI on “New SID on NR Positioning Enhancements” has been discussed in which one of the objectives is to:

Study solutions necessary to support integrity and reliability of assistance data and position information: [RAN2]
Identify positioning integrity KPIs and relevant use cases.
Identify the error sources, threat models, occurrence rates and failure modes requiring positioning integrity validation and reporting.
Study methodologies for network-assisted and UE-assisted integrity.

Integrity is referred to as the measure of trust that can be placed in the correctness of information supplied by a navigation system. Integrity includes the ability of a system to provide timely warnings to user receivers in case of failure. Example of a failure can be taken from a RAT independent positioning method such as Assisted GNSS: If a satellite is malfunctioning, it should be detected by the system and the user should be informed to not use this satellite.

Any use case related to positioning in Ultra Reliable Low Latency Communication (URLLC) typically requires high integrity performance. Example use cases include V2X, autonomous driving, UAV (drones), eHealth, rail and maritime, emergency and mission critical. In use cases in which large errors can lead to serious consequences such as wrong legal decisions or wrong charge computation, etc., the integrity reporting may become crucial.

FIG. 2 illustrates an example definition of accuracy, precision, validity, reliability and integrity. It can be assumed that “accuracy” is the same term as “validity” in positioning. Also, terms such as reliability, precision, certainty and confidence level can be used interchangeably. However, integrity requires the evaluation of both accuracy and reliability.

There are several example Integrity KPIs defined below that can help identify different integrity events:

Alert Limit (AL): is the largest error allowable for safe operation.

Time to Alert (TTA): is the maximum allowable elapsed time from the onset of a positioning failure until the equipment announces the alert.

Integrity Risk (IR): is the maximum probability of providing a signal that is out of tolerance without warning the user in a given period of time.

Protection Level (PL): is the statistical error bound computed to guarantee that the probability of the absolute position error exceeding the said number is smaller than or equal to the target integrity risk.

FIG. 3 illustrates an example Stanford plot in which the possible integrity operations and events can be explained in its different regions.

Nominal Operation is when the Position Error (PE) is less than the Protection Level (PL) which is less than the Alert Limit (AL) (e.g. PE<PL<AL).

System unavailable is when AL<PL.

Misleading Operation is when PL<PE.

Hazardously Operation is when PL<AL<PE.

Integrity Failure is an integrity event that lasts for longer than the TTA and with no alarm raised within the TTA.

Misleading Information (MI) is an integrity event occurring when, the system being declared available, the position error exceeds the protection level but not the alert limit.

Hazardously Misleading Information (HMI) is an integrity event occurring when, the system being declared available, the position error exceeds the alert limit.

### SUMMARY

It is an object of the present disclosure to obviate or mitigate at least one disadvantage of the prior art.

There are provided systems and methods for generating, configuring and using integrity parameters associated with positioning measurements and calculations.

In a first aspect there is provided a method performed by a network node. The network node can comprise a radio interface and processing circuitry and be configured to obtain a quality of service (QoS) for a positioning application. The network node determines an integrity key performance indicator (KPI) associated with the QoS and transmits, to a wireless device, the integrity KPI associated with the QoS.

In some embodiments, the integrity KPI associated with the QoS can be included in positioning assistance information.

In some embodiments, the integrity KPI associated with the QoS is determined based at least in part on one or more of: a positioning method to be used, the QoS for the positioning application, positioning measurements, and/or a capability associated with the wireless device.

In some embodiments, the integrity KPI associated with the QoS can include one or more of: a threshold parameter per QoS, an estimated integrity level, an achieved integrity level, a positioning measurement configuration to achieve a target integrity level, and/or a fault flag or recommendations for operation. The integrity KPI associated with the QoS can include an integrity risk (IR) parameter, the IR parameter indicating a maximum probability of providing a positioning service that is out of a tolerance range. The integrity KPI associated with the QoS can include an alert limit (AL) parameter, the AL parameter indicating a largest error allowable for safe operation. The integrity KPI associated with the QoS can include one or more Real Time Difference (RTD) threshold value or Reference Signal Received Power (RSRP) threshold value or Reference Signal Time Difference (RSTD) threshold value.

In some embodiments, the network node can receive, from the wireless device, an estimated position. In some embodiments, the network node can further receive, from the wireless device, at least one of an integrity level associated with the estimated position and/or a second integrity KPI. The network node can determine an integrity of the estimated position in accordance with the received second integrity KPI.

In another aspect there is provided a method performed by a wireless device. The wireless device can comprise a radio interface and processing circuitry and be configured to receive, from a network node, an integrity key performance indicator (KPI) associated with a quality of service (QoS). The wireless device performs positioning measurements to determine an estimated position of the wireless device and monitors the integrity KPI associated with the QoS while performing the positioning measurements.

In some embodiments, the integrity KPI associated with the QoS is included in positioning assistance information.

In some embodiments, the integrity KPI associated with the QoS can include one or more of: a threshold parameter per QoS, an estimated integrity level, an achieved integrity level, a positioning measurement configuration to achieve a target integrity level, and/or a fault flag or recommendations for operation. The integrity KPI associated with the QoS can include an integrity risk (IR) parameter, the IR parameter indicating a maximum probability of providing a positioning service that is out of a tolerance range. The integrity KPI associated with the QoS can include an alert limit (AL) parameter, the AL parameter indicating a largest error allowable for safe operation. The integrity KPI associated with the QoS can include one or more Real Time Difference (RTD) threshold value or Reference Signal Received Power (RSRP) threshold value or Reference Signal Time Difference (RSTD) threshold value.

In some embodiments, the wireless device determines a positioning method to use for the positioning measurements in accordance with the received integrity KPI associated with the QoS.

In some embodiments, the wireless device determines one or more cells to use for the positioning measurements in accordance with the received integrity KPI associated with the QoS.

In some embodiments, the wireless device can determine a second integrity KPI based at least in part on the received integrity KPI associated with the QoS. The second integrity KPI can include a Protection Level (PL) parameter, the PL parameter indicating a statistical error bound computed to guarantee that probability of a position error exceeding the PL is less than or equal to the integrity KPI associated with the QoS.

In some embodiments, the wireless device transmits, to the network node, the estimated position of the wireless device. The wireless device can further transmit, to the network node, at least one of: an integrity level associated with the estimated position and/or the second integrity KPI.

The various aspects and embodiments described herein can be combined alternatively, optionally and/or in addition to one another.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures, wherein:

FIG. 1 illustrates an example of NR positioning architecture;

FIG. 2 illustrates an example definition of reliability, accuracy, and integrity metrics;

FIG. 3 is an example Stanford plot;

FIG. 4a illustrates an example wireless network;

FIG. 4b illustrates an example of signaling in a wireless network;

FIG. 5 is an example signaling diagram;

FIG. 6 is an example integrity system;

FIG. 7 is an example of dynamic attributes;

FIG. 8 is a flow chart illustrating a method which can be performed in a positioning node;

FIG. 9 is a flow chart illustrating a method which can be performed in a network node;

FIG. 10 is a flow chart illustrating a method which can be performed in a wireless device;

FIG. 11 is a block diagram of an example wireless device;

FIG. 12 is a block diagram of an example wireless device with modules

FIG. 13 is a block diagram of an example network node;

FIG. 14 is a block diagram of an example network node with modules; and

FIG. 15 is a block diagram of an example virtualized processing node.

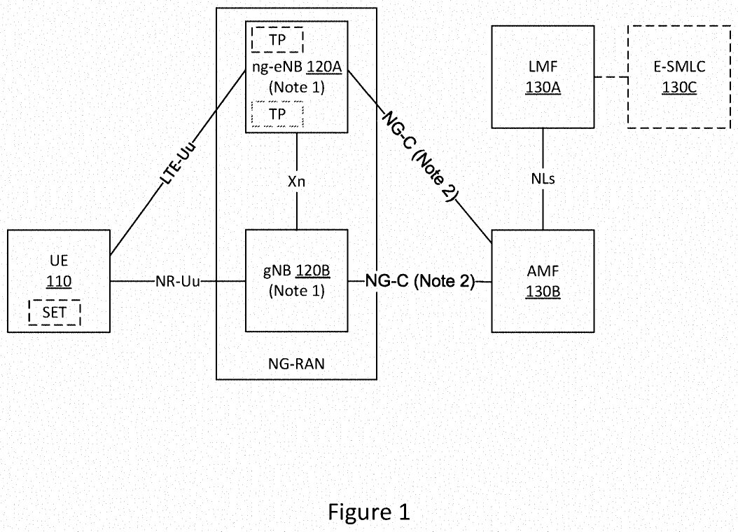

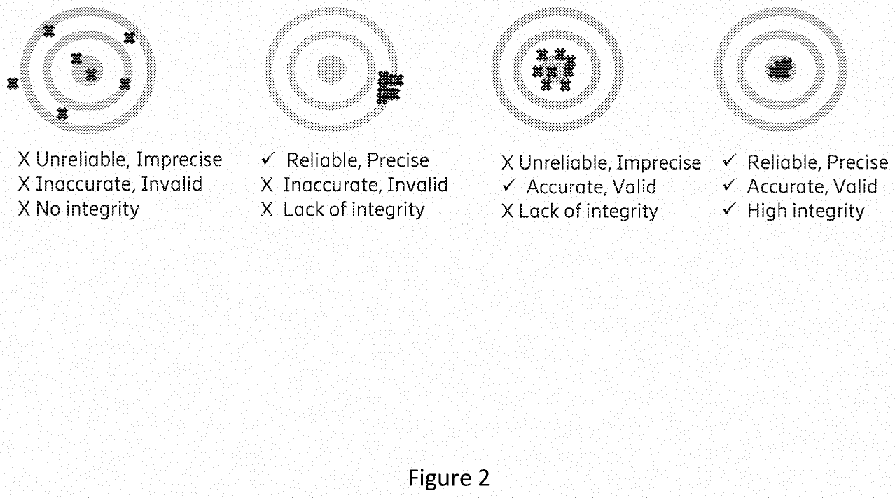

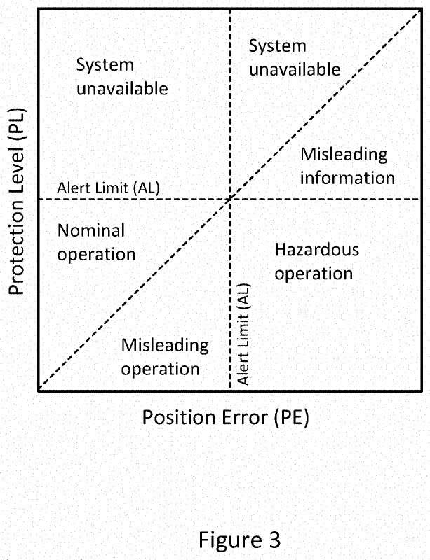

### DETAILED DESCRIPTION

The embodiments set forth below represent information to enable those skilled in the art to practice the embodiments. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

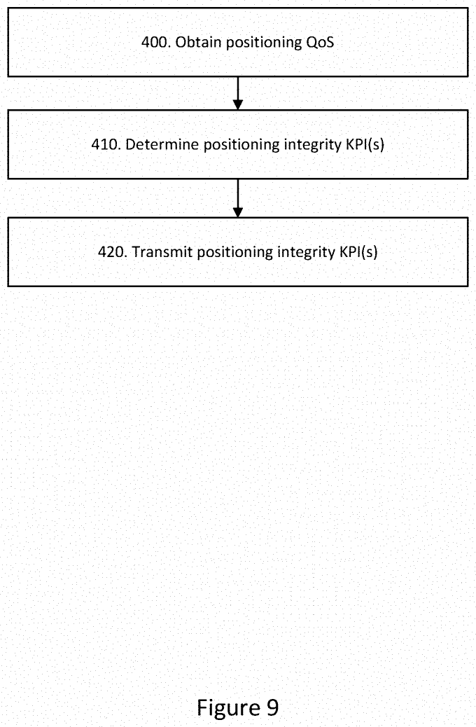

In some embodiments, the non-limiting term “user equipment” (UE) is used and it can refer to any type of wireless device which can communicate with a network node and/or with another UE in a cellular or mobile or wireless communication system. Examples of UE are target device, device to device (D2D) UE, machine type UE or UE capable of machine to machine (M2M) communication, personal digital assistant, tablet, mobile terminal, smart phone, laptop embedded equipped (LEE), laptop mounted equipment (LME), USB dongles, ProSe UE, V2V UE, V2X UE, MTC UE, eMTC UE, FeMTC UE, UE Cat 0, UE Cat M1, narrow band IoT (NB-IoT) UE, UE Cat NB1, etc. Example embodiments of a UE are described in more detail below with respect to FIG. 9.

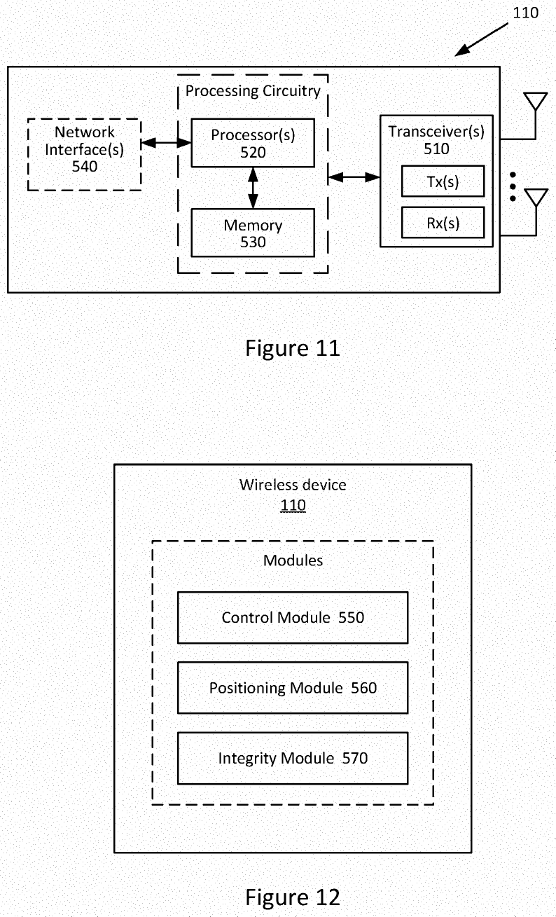

In some embodiments, the non-limiting term “network node” is used and it can correspond to any type of radio access node (or radio network node) or any network node, which can communicate with a UE and/or with another network node in a cellular or mobile or wireless communication system. Examples of network nodes are NodeB, MeNB, SeNB, a network node belonging to MCG or SCG, base station (BS), multi-standard radio (MSR) radio access node such as MSR BS, eNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc.), O&M, OSS, Self-organizing Network (SON), positioning node (e.g. E-SMLC), MDT, test equipment, etc. Example embodiments of a network node are described in more detail below with respect to FIG. 11.

In some embodiments, the term “radio access technology” (RAT) refers to any RAT e.g. UTRA, E-UTRA, narrow band internet of things (NB-IoT), WiFi, Bluetooth, next generation RAT (NR), 4G, 5G, etc. Any of the first and the second nodes may be capable of supporting a single or multiple RATs.

The term “radio node” used herein can be used to denote a wireless device or a network node.

In some embodiments, a UE can be configured to operate in carrier aggregation (CA) implying aggregation of two or more carriers in at least one of downlink (DL) and uplink (UL) directions. With CA, a UE can have multiple serving cells, wherein the term ‘serving’ herein means that the UE is configured with the corresponding serving cell and may receive from and/or transmit data to the network node on the serving cell e.g. on PCell or any of the SCells. The data is transmitted or received via physical channels e.g. PDSCH in DL, PUSCH in UL, etc. A component carrier (CC) also interchangeably called as carrier or aggregated carrier, PCC or SCC is configured at the UE by the network node using higher layer signaling e.g. by sending RRC configuration message to the UE. The configured CC is used by the network node for serving the UE on the serving cell (e.g. on PCell, PSCell, SCell, etc.) of the configured CC. The configured CC is also used by the UE for performing one or more radio measurements (e.g. RSRP, RSRQ, etc.) on the cells operating on the CC, e.g. PCell, SCell or PSCell and neighboring cells.

In some embodiments, a UE can also operate in dual connectivity (DC) or multi-connectivity (MC). The multicarrier or multicarrier operation can be any of CA, DC, MC, etc. The term “multicarrier” can also be interchangeably called a band combination.

The term “radio measurement” used herein may refer to any measurement performed on radio signals. Radio measurements can be absolute or relative. Radio measurements can be e.g. intra-frequency, inter-frequency, CA, etc. Radio measurements can be unidirectional (e.g., DL or UL or in either direction on a sidelink) or bidirectional (e.g., RTT, Rx-Tx, etc.). Some examples of radio measurements: timing measurements (e.g., propagation delay, TOA, timing advance, RTT, RSTD, Rx-Tx, etc.), angle measurements (e.g., angle of arrival), power-based or channel quality measurements (e.g., path loss, received signal power, RSRP, received signal quality, RSRQ, SINR, SNR, interference power, total interference plus noise, RSSI, noise power, CSI, CQI, PMI, etc.), cell detection or cell identification, RLM, SI reading, etc. The measurement may be performed on one or more links in each direction, e.g., RSTD or relative RSRP or based on signals from different transmission points of the same (shared) cell.

The term “signaling” used herein may comprise any of high-layer signaling (e.g., via RRC or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “time resource” used herein may correspond to any type of physical resource or radio resource expressed in terms of length of time. Examples of time resources include symbol, time slot, sub-frame, radio frame, TTI, interleaving time, etc. The term “frequency resource” may refer to sub-band within a channel bandwidth, subcarrier, carrier frequency, frequency band. The term “time and frequency resources” may refer to any combination of time and frequency resources.

Some examples of UE operation include: UE radio measurement (see the term “radio measurement” above), bidirectional measurement with UE transmitting, cell detection or identification, beam detection or identification, system information reading, channel receiving and decoding, any UE operation or activity involving at least receiving of one or more radio signals and/or channels, cell change or (re)selection, beam change or (re)selection, a mobility-related operation, a measurement-related operation, a radio resource management (RRM)-related operation, a positioning procedure, a timing related procedure, a timing adjustment related procedure, UE location tracking procedure, time tracking related procedure, synchronization related procedure, MDT-like procedure, measurement collection related procedure, a CA-related procedure, serving cell activation/deactivation, CC configuration/de-configuration, etc.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”. However, particularly with respect to 5G/NR concepts, beams may be used instead of cells and, as such, it is important to note that the concepts described herein are equally applicable to both cells and beams.

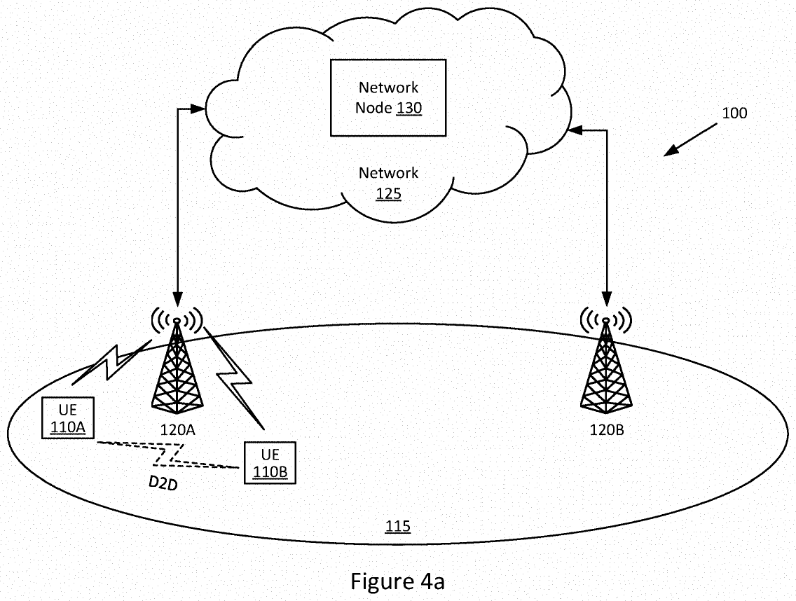

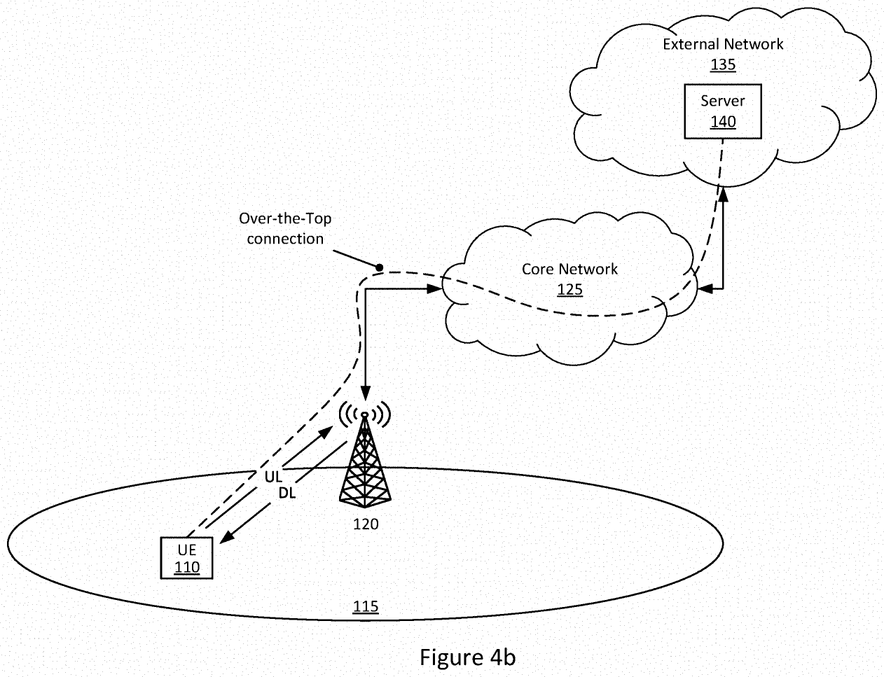

FIG. 4a illustrates an example of a wireless network 100 that can be used for wireless communications. Wireless network 100 includes wireless devices, such as UEs 110A-110B, and network nodes, such as radio access nodes 120A-120B (e.g. eNBs, gNBs, etc.), connected to one or more core network nodes 130 via an interconnecting network 125. The network 100 can use any suitable deployment scenarios. UEs 110 within coverage area 115 can each be capable of communicating directly with radio access nodes 120 over a wireless interface. In some embodiments, UEs 110 can also be capable of communicating with each other via D2D communication.

As an example, UE 110A can communicate with radio access node 120A over a wireless interface. That is, UE 110A can transmit wireless signals to and/or receive wireless signals from radio access node 120A. The wireless signals can contain voice traffic, data traffic, control signals, and/or any other suitable information. In some embodiments, an area of wireless signal coverage 115 associated with a radio access node 120 can be referred to as a cell.

The interconnecting network 125 can refer to any interconnecting system capable of transmitting audio, video, signals, data, messages, etc., or any combination of the preceding. The interconnecting network 125 can include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the network node 130 can be a core network node 130, managing the establishment of communication sessions and other various other functionalities for UEs 110. Examples of core network node 130 can include mobile switching center (MSC), MME, serving gateway (SGW), packet data network gateway (PGW), operation and maintenance (O&M), operations support system (OSS), SON, positioning node (e.g., Enhanced Serving Mobile Location Center, E-SMLC), location server node, MDT node, etc. UEs 110 can exchange certain signals with the core network node using the non-access stratum layer. In non-access stratum signaling, signals between UEs 110 and the core network node 130 can be transparently passed through the radio access network. In some embodiments, radio access nodes 120 can interface with one or more network nodes 130 over an internode interface.

In some embodiments, radio access node 120 can be a “distributed” radio access node in the sense that the radio access node 120 components, and their associated functions, can be separated into two main units (or sub-radio network nodes) which can be referred to as the central unit (CU) and the distributed unit (DU). Different distributed radio network node architectures are possible. For instance, in some architectures, a DU can be connected to a CU via dedicated wired or wireless link (e.g., an optical fiber cable) while in other architectures, a DU can be connected a CU via a transport network. Also, how the various functions of the radio access node 120 are separated between the CU(s) and DU(s) may vary depending on the chosen architecture.

FIG. 4b illustrates an example of signaling in wireless network 100. As illustrated, the radio interface generally enables the UE 110 and the radio access node 120 to exchange signals and messages in both a downlink direction (from the radio access node 120 to the UE 110) and in an uplink direction (from the UE 110 to the radio access node 120).

The radio interface between the wireless device 110 and the radio access node 120 typically enables the UE 110 to access various applications or services provided by one or more servers 140 (also referred to as application server or host computer) located in an external network(s) 135. The connectivity between the UE 110 and the server 140, enabled at least in part by the radio interface between the UE 110 and the radio access node 120, can be described as an “over-the-top” (OTT) or “application layer” connection. In such cases, the UE 110 and the server 140 are configured to exchange data and/or signaling via the OTT connection, using the radio access network 100, the core network 125, and possibly one or more intermediate networks (e.g. a transport network, not shown). The OTT connection may be transparent in the sense that the participating communication devices or nodes (e.g., the radio access node 120, one or more core network nodes 130, etc.) through which the OTT connection passes may be unaware of the actual OTT connection they enable and support. For example, the radio access node 120 may not or need not be informed about the previous handling (e.g., routing) of an incoming downlink communication with data originating from the server 140 to be forwarded or transmitted to the UE 110. Similarly, the radio access node 120 may not or need not be aware of the subsequent handling of an outgoing uplink communication originating from the UE 110 towards the server 140.

Returning to positioning performance metrics, in the conventional positioning support of LTE and NR networks, there is no network assistance in terms of integrity reporting. Therefore, a UE is not capable of assessing its positioning estimation integrity. This can be considered an important parameter when dealing with use cases requiring high reliability of the positioning accuracy. No integrity support has been specified thus far in 3GPP for RAT-dependent positioning use cases.

In general, in order for the UE and the network to assess the integrity of the positioning estimation, it is important that they first both have the same definitions and rules of how to set their positioning Integrity KPIs, and also to transfer this knowledge and the related parameters in an efficient manner. In some embodiments, the various factors governing the Integrity KPIs have been taken into consideration and methods for how this information can be used at both the network and the target device are described. These factors, which can impact the integrity assessment of either positioning methods (one or combination thereof or hybrid methods) and measurements, can be static or known prior to the initiation of the positioning procedure, or they may be semi-static or dynamic attributes.

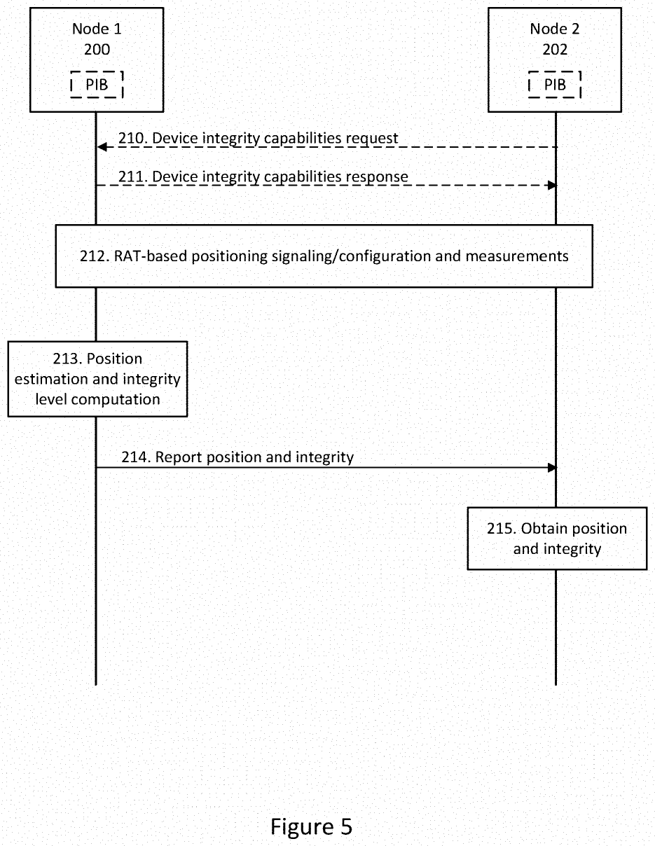

FIG. 5 is an example signaling diagram illustrating the basic signaling steps from the perspective of a network node (e.g. gNB 120 or location server 130) and a target device (e.g. UE 100) according to certain embodiments, in which either of the network nodes can become the node which computes the integrity level (Node 1 200) and share it with the other node (Node 2 202). In the example of FIG. 5, possible combinations of Node 1 200 and Node 2 202 can include, but are not limited to: LMF-UE, LMF-gNB, gNB-gNB, gNB-UE, etc. A Positioning Integrity Block (PIB) is a logical entity that can be located in a LMF, gNB, UE or independently in another (e.g. standalone) node.

Network nodes 200 and 202 can exchange capabilities information related to device integrity (steps 210, 211). In step 212, Node 1 200 and Node 2 202 perform RAT-based positioning signaling/configuration and measurements. Node 1 200 can estimate the position (e.g. based on the measurements) and compute the associated integrity level (step 213). The integrity level can be computed based on static, semi-static, and/or dynamic attributes. Node 1 200 can then report the positioning measurements and the computed integrity level (step 214). Accordingly, Node 2 202 obtains the positioning and integrity information (step 215).

It will be appreciated that some positioning-related messages (e.g. request, response, report, acknowledgement, etc.) could be mandated as part of the procedure in some implementations (i.e. not configurable), while in other implementations they can be configurable through signaling.

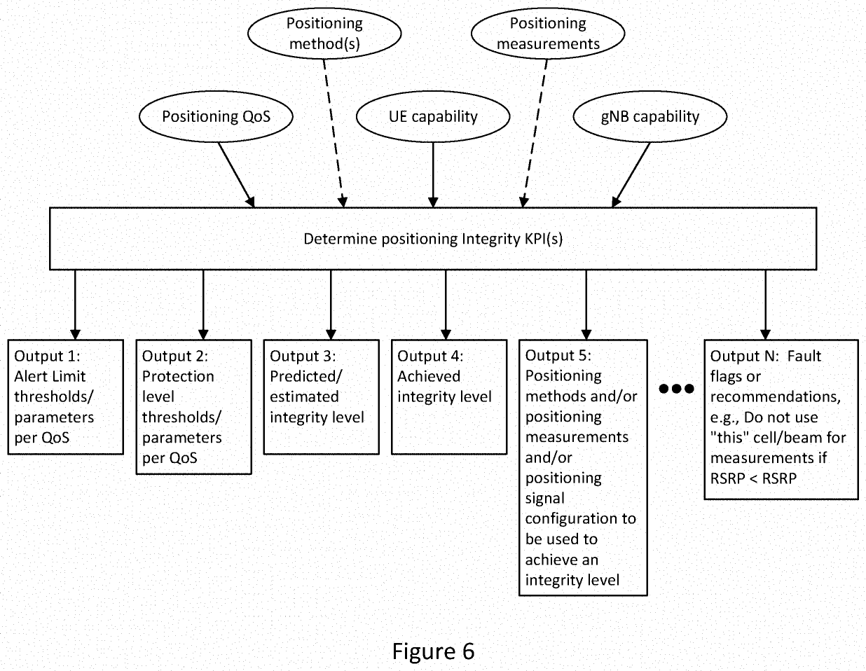

FIG. 6 illustrates an example integrity system in which different parameters can contribute to positioning integrity KPI determination and potential outputs from the integrity system. This can be included as part of the PIB.

Examples of potential inputs include: the positioning method(s) to be used, the positioning QoS, the positioning measurements, and the UE/gNB capabilities. The Integrity KPI(s) can be determined and/or monitored based at least in part on some of these inputs. Example outputs from the integrity system include: AL threshold/parameter(s) per QoS, PL threshold/parameter(s), estimated integrity level(s), achieved integrity level(s), positioning measurement configuration to achieve a target integrity level, fault flags or recommendations for operation, etc.

In one example, the integrity system (e.g. PIB) can be deployed in a separate network node or can be included in positioning node and/or radio network node, as a logical entity. In another example, the integrity system can be distributed between a network node 120/130 and UE 110, e.g. some functionalities are in the UE and some are in the network node.

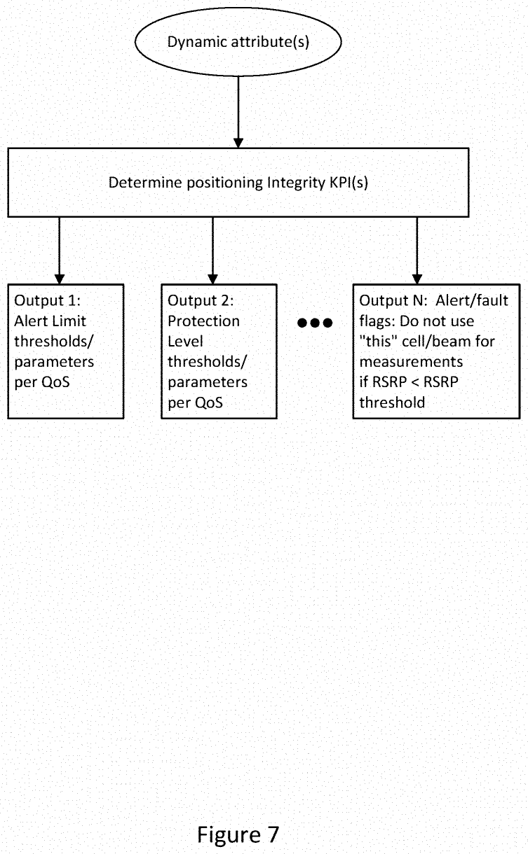

FIG. 7 illustrates an example of how dynamic attributes can impact integrity KPIs. The function “Determine Integrity KPI” can be performed either in a network node 120/130 (e.g. LMF and/or BS positioning function) or in the UE 110. Similar to FIG. 6, one or more dynamic attributes can contribute to the integrity KPI determination and output(s) from the integrity system.

Some embodiments described herein provide solutions for integrating and determining the integrity KPI of RAT dependent positioning methods. Accordingly, the network can assist a device in terms of alert limit, integrity risk, protection level of RAT dependent positioning methods by considering the static fields that govern the Integrity KPI. The device can assess its positioning estimation and the associated integrity level considering various factors governing KPI. Dynamic attributes can be considered to compute the integrity KPIs.

In some embodiments, examples of the static (or known or pre-defined) factors can include the following:
The positioning QoS (Location Accuracy needed) can influence how Integrity KPIs (threshold parameters are set), e.g., for high QoS, more stringent integrity KPI values are set as threshold compared to low QoS.
The UE capability of performing accurate and different positioning measurements and supporting a variety of positioning methods as well as accurate reporting. An Integrity KPI based upon UE measurements may vary depending upon whether the UE supports a set of complementary positioning methods or hybrid positioning methods or their ability to support positioning quality in a larger range (including high-accuracy positioning), since this provides more flexibility for integrity KPIs. For example, a UE performing hybrid positioning method may have relaxed Integrity KPI (e.g., measurement thresholds) as compared to a non-capable UE. UE's sensor support (IMU, etc.) which can augment the positioning measurement may also influence or guide in setting the integrity KPI. In other words, when the UE is capable of performing more measurements and positioning methods, then it is possible for both the network and the UE to increase the reliability of the positioning estimation as it is possible to outlie any potential error source. By improving the reliability of the positioning accuracy, the integrity KPI can be set to a higher level for such scenarios. One example can be the integrity of vehicular positioning, where the vehicle is able to estimate its position via GNSS, cellular network, camera and/or IMU sensors. The overall position estimation from the hybrid positioning of all the systems would provide high integrity.
Similar to UE capability, the network capability to support a variety of positioning methods (including angular positioning methods), accurate and different measurements for positioning (including gNB RxTx time difference measurements), beam forming, more positioning assistance information (more parameters, more details, higher granularity, etc.) can all potentially lead to a higher integrity system.

These static factors are enablers for setting ranges and thresholds of the integrity level of the system, and also make possible to consider the impact of dynamic attributes (e.g., in case the UE is not capable of assessing integrity KPIs, then the dynamic attributes related to integrity KPIs can be ignored as they may have no potential impact). The KPI can be defined with respect to any one or more of: positioning assistance data, positioning measurements, and/or positioning estimate.

In one example, the following non-limiting integrity levels can be defined for the overall positioning system including both the UE and the network. Depending on the purpose and the node, the levels can be determined: before (e.g. the requested or a predicted integrity level or promised/available integrity level), during (e.g. the currently perceived or achieved integrity level or its estimate based on the progress so far), or after (e.g. the actually perceived integrity level) performing positioning measurements and/or position calculation/estimation. The network and a UE may support the operation at all or a subset of levels, which may also be a part of their respective capabilities.

No integrity: This can indicate that the system has no means to assess the integrity level of the positioning estimation. As there is no systematic way, there is no way to justify the reliability and/or timeliness (actuality) of the obtained position estimation from the UE or the network.

Low integrity: This can indicate that the integrity KPIs and thresholds are defined; however, the AL and PL are set so high that the system rarely has any issue with unavailability or misleading operation. The position error can also be quite high while both the network and the UE are not alerted about it.

Medium integrity: This can indicate that the integrity KPIs and thresholds are defined, and the AL and PL are set such that sometimes the system may provide failure errors due to unavailability of proper position estimation, or notifying on the potential of misleading information, etc.

High integrity: This can indicate that the integrity KPIs and thresholds are defined, and the AL and PL are set such tight that unless the positioning error is below some small amount, the system would not accept the performance and there is a need to repeat the measurement or add extra positioning technique to improve the position estimation. So as long as the system reports a position estimation, it is quite highly guaranteed that it is a very reliable value.

In some embodiments, semi-static attributes can be considered as the quality of input that is needed for the main positioning method such as:
For DL-TDOA, input from ECID positioning method is considered to be a pre-requisite. However, if the UE does not report or the reported value is not very recent one for ECID positioning method, there may be large error that could be expected for DL-TDOA.
Further for multi-RTT positioning method, the beam sweep result is required prior so the NW can inform to the UE with regards to spatial relation between DL and UL RS. If the UE does not provide the beam sweep result it may be difficult to ascertain the spatial relations.
Training data available for fingerprinting (E-CID).

In some embodiments, examples of dynamic factors based upon the dynamic attributes, once the positioning methods/measurements have started, can include the following:
Frequency of measurement feedback between UE and the network.
Assistance Data (AD) Delivery Mechanism: The AD can be delivered using either broadcast or unicast. If it is performed using unicast, it is per UE, thus the network may be able to tune the AD per UE. However, for broadcast, the AD needs to validate for all UE in a cell. Due to broadcast size limitations, it may not be possible to provide huge amount of AD and the broadcast periodicity may be longer.
Uncertainty/Quality of Measurements: The uncertainty may be based upon the UE or network assessment of LoS/NLoS detection, PRS RSRP, PRS SINR.
Other Events: The network can consider parameters such as Radio Link Failures, Handover failures, Poor coverage detection from UE or other UE in same area.
UE Velocity, Doppler's effect, etc.
Interference (RSSI or total interference plus noise).
Rate of change (drift rate) of synchronization error between base stations.

In some embodiments, the various attributes influencing the Positioning Integrity KPI(s) can be classified into static, semi-static and dynamic attributes as follows:
Based upon the static attributes, set the Integrity Level to {No, Low, Medium, High}

IL∈{No,Low,Medium,High}
Set different AL, PL, IR for each of the Integrity Level(s) such that IL High has stringent requirements/rules and low has relaxed requirements/rules
   High IL: Threshold X1
   Low IL: Threshold X2

such that the relationship between X1 and X2 is such that X1 has a higher bar (threshold) than X2.
Update/optimize the AL, PL, IR within an Integrity after considering the semi-static and dynamic attribute into account to further update/optimize the AL, PL, IR within an Integrity level

High IL: X1+δX1

Low IL: X2+δX2

The expression can be plus or minus; or the change in X1 or X2 can be negative too.

For RAT dependent positioning methods such as DL-TDOA, Multi-Cell RTT, the UE is required to perform the PRS measurements from various cells/beams. The quality of received PRS in the UE in terms of SINR, RSRP, RSRQ, LoS or NLos plays a role in identifying the uncertainty or the quality/accuracy of computed UE location.

Further, for DL-TDOA, GDOP is also an important attribute that can influence the positioning calculation.

QoS differs for different positioning applications. Some of the applications can tolerate large errors (uncertainly) whereas some of the applications can only tolerate very marginal errors.

In some embodiments, the network node provides the integrity (Alert Limit or Protection Level) based upon different QoS. For UEs operating in UE based mode, it can provide via broadcast or unicast, different threshold parameters that the UE should adhere to maintain the desired integrity.

In an example:

QoS Level 1: PRS RSRP>−84 dBm

QoS Level 2: PRS RSRP>−102 dBm

Thus, UE should only consider the cells which meet the QoS.

Depending upon the UE and gNB capabilities the threshold may further be revised. For example, if UE supports hybrid positioning method then that can basically augment the positioning calculation or help in reducing/compensating the uncertainty. Further UEs capable of RAT dependent and RAT independent may cross verify.

In another example:

QoS Level 1: Hybrid Positioning method support (UE RxTx, TDOA, AoD): then PRS RSRP>−102 dBm

QoS Level 2: No Hybrid Positioning method support PRS RSRP>−84 dBm

Further for some of the QoS class, additional constraint(s) can be defined based upon other factors such as GDOP. The constrains can be added either based upon “and” or “or” operations.

QoS Level 1: PRS RSRP>−84 dBm(&&∥)GDOP<5

In an alternative embodiment, a fault flag (e.g. “Do not use”) can be set so that the UE can discard any cell/beam that has RSRP<threshold.

In an alternative embodiment, the “Determine Integrity KPI” function can consider the dynamic attributes and adopt the output (e.g. Alert Limit, Integrity Risk, Protection Level) accordingly. For example, based upon information of UE speed; the protection level constraint may be higher for high speed UE than low speed UE.

Further, the quality of pre-requisite input needed for the positioning method can also determine the AL, PL. If the needed input is of high quality, it is expected that the ranging error, positioning estimation error would be low. In such case, a Loss of Integrity event (unsafe condition) occurring is low; an unsafe condition (i.e. the probability of a positioning error higher than the protection level is low).

The frequency of measurement report from UE and gNB can also influence the alert limit (e.g. when to alert). If there is an active feedback and exchange among UE, gNB and LMF, in such cases it is possible to adopt the needed Assistance Data (AD) more tuned to the UE need. A longer time to alert can be set in this scenario. The warning (or alert) of any malfunction to users within a given period of time (time-to-alert) would not be as critical as the network node may already correct such malfunction via a new AD based upon UE/gNB feedback on the measurement quality. When the UE is providing active feedback, it is expected that UE is in connected mode (LPP connected) and obtaining dedicated/unicast (AD). In some embodiments, AL, PL can vary depending upon the delivery mode of AD. For example, for broadcast, it can be more stringent than for unicast.

In some embodiments, the integrity system may need to build a knowledge database and algorithms which can be pre-configured, or it can be built/updated dynamically, based on inputs from different nodes (UE or network nodes).

In one example, a UE provides its position and the associated integrity KPI(s) and the integrity system uses these inputs to update its knowledge database. This information may further be used e.g. for positioning other UEs or configuring the positioning for other UEs.

In another example, a network node (e.g. gNB) provides its one or more configurations for positioning and the associated integrity KPI. This input can be further used by the integrity system to select the necessary configuration for positioning UE with a given integrity level.

The integrity system knowledge database and the algorithms can be used to provide a response or a configuration to a request between any of UE, gNB, or positioning node (e.g. request from UE/response to UE, from positioning node/to positioning node, from gNB/to gNB, from positioning node/to gNB, request from UE/configuration to gNB, request from positioning node/configuration to gNB, etc.).

In one example, the integrity system receives a request for an estimated integrity level for a combination {UE capability, QoS target(s)} and provides a response {estimated integrity level, positioning method(s) which can be used}. This can then be used to select positioning methods and/or measurements.

In another example, the integrity system receives a request for an estimated integrity level for a combination {positioning method(s), QoS target(s)} and provides a response {estimated integrity level(s) per method/QoS target}, which can then be used to select positioning methods and/or measurements.

In another example, the integrity system receives a request for positioning at a certain integrity level and in response provides or indicates the necessary {assistance data or positioning configurations} for one or more positioning methods or measurements, necessary to achieve the requested integrity level.

In another example, the integrity system receives positioning measurements and may also further receive one or more integrity KPIs characterizing the measurements. Based on these inputs, the integrity system provides the positioning result and the achieved integrity KPI associated with the positioning result.

### ASN.1 Examples

A common Information Element (IE) can be used to fetch the UE capability in terms of informing the support of integrity. The integrity level that UE supports and the integrity KPIs that the UE support. The location server may request with below information from UE and implicitly also suggesting that LMF supports the requested capabilities.

It is also possible to provide a separate IE for Integrity related message handling or merge it with existing LPP positioning methods.

CommonIEsRequestCapabilities

The CommonIEsRequestCapabilities carries common IEs for a Request Capabilities LPP message Type.

```
-- ASN1START
CommonIEsRequestCapabilities ::= SEQUENCE {
  ...,
  [[
  lpp-message-segmentation-req-r14 BIT STRING { serverToTarget (0),
```

targetToServer (1) } OPTIONAL -

```
- Need ON
  ]],
  [[
```

| integritySupport-r17 | BIT STRING { | noIntegiry (0), |
|---|---|---|
| | | lowInegrity (1) |
| | | mediumInegrity (2), |
| | | HighInegrity (3) } |
| integritySupportKPI-r17 | BIT STRING { | alertLimit (0), |

integrityRisk (1)
protectionLevel (2)}
alertTime (3) }

]]
}
-- ASN1STOP

CommonIEsRequestCapabilities field descriptions

lpp-message-segmentation-req
This field, if present, indicates that the target device is requested to provide its LPP message
segmentation capabilities.
If bit 0 is set to value 1, it indicates that the server is able to send segmented LPP messages to the target
device; if bit 0 is set to value 0 it indicates that the server is not able to send segmented LPP messages to
the target device.
If bit 1 is set to value 1, it indicates that the server is able to receive segmented LPP messages from the
target device; if bit 1 is set to value 0 it indicates that the server is not able to receive segmented LPP
messages from the target device.

CommonIEsProvideCapabilities

The CommonIEsProvideCapabilities carries common IEs for a Provide Capabilities LPP message Type.

```
-- ASN1START
CommonIEsProvideCapabilities ::= SEQUENCE {
  ...,
  [[
```

| | |
|---|---|
| segmentationInfo-r14 | SegmentationInfo-r14 OPTIONAL, -- Cond |

Segmentation

| | | |
|---|---|---|
| lpp-message-segmentation-r14 | BIT STRING { | serverToTarget (0), |

targetToServer (1) } OPTIONAL

```
  ]] ,
  [[
```

| integritySupport-r17 | BIT STRING { | noIntegiry (0), |
|---|---|---|
| | | lowInegrity (1) |
| | | mediumInegrity (2), |
| | | HighInegrity (3) } |
| integritySupportKPI-r17 | BIT STRING { | alertLimit (0), |

integrityRisk (1)
protectionLevel (2)}

]]
}
-- ASN1STOP

The “noIntegrity” bit in the above example can be also represented for unsupported and also that the UE does not have the capability or does not want to have integrity fixes.

In some embodiments, the network can provide different thresholds for the Real Time Difference (RTD).

NR-RTD-Info

The IE NR-RTD-Info is used by the location server to provide time synchronization information between a reference TRP and a list of neighbour TRPs.

-- ASN1START
NR-RTD-Info-r16 ::= SEQUENCE {

| | |
|---|---|
| referenceTRP-RTD-Info-r16 | ReferenceTRP-RTD-Info-r16, |
| rtd-InfoList-r16 | RTD-InfoList-r16, |

...
}
ReferenceTRP-RTD-Info-r16 ::= SEQUENCE {

| | |
|---|---|
| ref-trp-id-r16 | TRP-ID-r16, |
| refTime-r16 | CHOICE { |

| | |
|---|---|
| systemFrameNumber-r16 | BIT STRING (SIZE (10)), |
| utc-r16 | UTCTime, |

```
    ...
  },
```

| | | |
|---|---|---|
| rtd-RefQuality-r16 | NR-TimingMeasQuality-r16 | OPTIONAL, - |

- Need ON
...
}
RTD-InfoList-r16 ::= SEQUENCE (SIZE (1..4)) OF RTD-InfoListPerFreqLayer-r16
RTD-InfoListPerFreqLayer-r16 ::= SEQUENCE (SIZE(1..63)) OF RTD-InfoElement-
r16
RTD-InfoElement-r16 ::= SEQUENCE {

| | |
|---|---|
| trp-id-r16 | TRP-ID-r16, |
| subframeOffset-r16 | INTEGER (0..1966079), |
| rtd-Quality-r16 | NR-TimingMeasQuality-r16, |

```
  ...,
  [[
```

| | | |
|---|---|---|
| rtd-HighIntegrityThreshold-r17 | INTEGER (0..1966079) | OPTIONAL, |
| rtd-MediumIntegrityThreshold-r17 | INTEGER (0..1966079) | OPTIONAL, |
| rtd-LowIntegiryThreshold-r17 | INTEGER (0..1966079) | OPTIONAL |

]]
}
-- ASN1STOP

NR-RTD-Info field descriptions

referenceTRP-RTD-Info
This field defines the reference TRP for the RTD and comprises the following sub-fields:
ref-trp-id: This field specifies the identity of the reference TRP.
refTime: This field specifies the reference time at which the rtd-InfoList is valid. The
systemFrameNumber choice refers to the SFN of the reference TRP.
rtd-RefQuality: This field specifies the quality of the timing of reference TRP, used to determine the
RTD values provided in rtd-InfoList.
trp-id-r16
This fields provides the identity of the TRP for which the RTD-InfoElement is applicable.
subframeOffset
This field specifies the subframe boundary offset at the TRP antenna location between the reference TRP
and this neighbour TRP in time units T_{c} = 1/(Δfₘₐₓ · N_{f}) where Δfₘₐₓ = 480 · 10³ Hz and N_{f} = 4096 (TS
38.211 [41]).
The offset is counted from the beginning of a subframe #0 of the reference TRP to the beginning of the
closest subsequent subframe of this neighbour TRP.
Scale factor 1 Tc.
rtd-Quality
This field specifies the quality of the RTD.
rtd-HighIntegrityThreshold
RTD High Integrity. The unit is in subframes. UE shall ignore the cells/TRPs which has higher RTD values
than the thresholds.
UE may use this for calculating the alertLimit, protection level.
rtd-MediumIntegrityThreshold
RTD Medium Integrity. The unit is in subframes. UE shall ignore the cells/TRPs which has higher RTD
values than the thresholds.
UE may use this for calculating the alertLimit, protection level.
rtd-LowIntegrityThreshold
RTD Low Integrity. The unit is in subframes. UE shall ignore the cells/TRPs which has higher RTD values
than the thresholds.
UE may use this for calculating the alertLimit, protection level.

In some embodiments, an RSRP threshold can also be provided for DL PRS Assistance data.

NR-DL-PRS-AssistanceData

The IE NR-DL-PRS-AssistanceData is used by the location server to provide DL-PRS assistance data.

```
-- ASN1START
NR-DL-PRS-AssistanceData-r16 ::= SEQUENCE {
  nr-DL-PRS-ReferenceInfo-r16 DL-PRS-IdInfo-r16 OPTIONAL, -- Need ON
  nr-DL-PRS-AssistanceDataList-r16 SEQUENCE (SIZE (1..nrMaxFreqLayers)) OF
NR-DL-PRS-AssistanceDataPerFreq-r16,
```

| | |
|---|---|
| nr-SSB-Config-r16 | SEQUENCE (SIZE (0..255)) OF NR-SSB-Config-r16, |

```
  ...
}
NR-DL-PRS-AssistanceDataPerFreq-r16 ::= SEQUENCE {
  nr-DL-PRS-AssistanceDataPerFreq (SIZE (1..nrMaxTRPsPerFreq)) OF NR-DL-PRS-
AssistanceDataPerTRP-r16,
  nr-DL-PRS-PositioningFrequencyLayer-r16 NR-DL-PRS-
```

| | |
|---|---|
| PositioningFrequencyLayer-r16 | OPTIONAL, --Need ON |

...
}
NR-DL-PRS-AssistanceDataPerTRP-r16 ::= SEQUENCE {

| | |
|---|---|
| nr-DL-PRS-expectedRSTD-r16 | INTEGER (−3841..3841), |

nr-DL-PRS-expectedRSTD-uncerainty-r16 INTEGER (−246..246),

| | |
|---|---|
| trp-ID-r16 | TRP-ID-r16 OPTIONAL, |

| | |
|---|---|
| nr-DL-PRS-Config-r16 | NR-DL-PRS-Config-r16, |

```
  ...,
  [[
```

| | |
|---|---|
| RSRP-HighIntegrityThreshold-r17 | INTEGER (0..97) |
| RSRP-MediumIntegrityThreshold-r17 | INTEGER (0..97) |
| RSRP-LowIntegrityHighThreshold-r17 | INTEGER (0..97) |
| expectedRSTD-HighIntegrityThreshold-r17 | INTEGER (−3841..3841), |
| expectedRSTD-unceraintyHighThreshold-r17 | INTEGER (−246..246), |

]]
}
NR-DL-PRS-PositioningFrequencyLayer-r16 ::= SEQUENCE {

| | |
|---|---|
| dl-PRS-SubcarrierSpacing-r16 | ENUMERATED {kHz15, kHz30, kHz60, kHz120, |

...},

| | |
|---|---|
| dl-PRS-ResourceBandwidth-r16 | INTEGER (1..63), |
| dl-PRS-StartPRB-r16 | INTEGER(0..2176), |
| dl-PRS-PointA-r16 | ARFCN-ValueNR-r15, |
| dl-PRS-CombSizeN-r16 | ENUMERATED {n2, n4, n6, n12, ...), |
| dl-PRS-CyclicPrefix-r16 | ENUMERATED {normal, extended, ...), |

...
}
nrMaxFreqLayers INTEGER ::= 4 -- Max freq layers
nrMaxTRPsPerFreq INTEGER ::= 64 -- Max TRPs per freq layers

| | |
|---|---|
| nrMaxResourceIDs INTEGER ::= 64 | -- Max ResourceIDs |

-- ASN1STOP

NR-DL-PRS-AssistanceData field descriptions

nr-DL-PRS-Config
This field specifies the PRS configuration of the TRP.
nr-DL-PRS-ReferenceInfo
This field indicates the IDs of the reference TRP.
nr-DL-PRS-ResourceID-List
The list of nr-DL PRS resource ID. Only a single nr-DL-PRS-ResourceId is included if the field is used in
measurement reporting.
RSRP-HighIntegrityThreshold
Alert Limit for High Integrity RSRP Threshold. UE shall ignore the cells which has expected RSTD above
this threshold.
expectedRSTD-HighIntegrityThreshold
Alert Limit for expected RSTD DL PRS for high integrity. UE shall ignore the cells which has expected
RSTD above this threshold.

In some embodiments, for time to alert, the location server provides to UE informing for UEs operating in UE-Assisted mode when the location server should alert the UE after discovering the error. For UE operating in UE based mode, UE shall follow the time to alert to inform the location server regarding the positioning error. Further, an example is provided where a location server informs to the UE that there is an integrity failure.

CommonIEsProvideAssistanceData

The CommonIEsProvideAssistanceData carries common IEs for a Provide Assistance Data LPP message Type.

```
-- ASN1START
CommonIEsProvideAssistanceData ::= SEQUENCE {
  ...,
  [[
```

| | | |
|---|---|---|
| segmentationInfo-r14 | SegmentationInfo-r14 | OPTIONAL -- Need ON |

```
  ]],
  [[
    periodicAssistanceData-r15 PeriodicAssistanceDataControlParameters-
r15
```

OPTIONAL -- Cond PerAD

]],

| | |
|---|---|
| alertTimeHigh-r17 | INTEGER (0..FFS) OPTIONAL, |
| alertTimeMedium-r17 | INTEGER (0..FFS) OPTIONAL, |
| alertTimeLow-r17 | INTEGER (0..FFS) OPTIOANl, |
| integrityFailure-r17 | ENUMERATED {true} OPTIONAL |

}
-- ASN1STOP

In some embodiments, a separate IE can be provided for Integrity Support.

ProvideAssistanceData

The ProvideAssistanceData message body in an LPP message can be used by the location server to provide assistance data to the target device either in response to a request from the target device or in an unsolicited manner.

-- ASN1START
ProvideAssistanceData ::= SEQUENCE {

| | |
|---|---|
| criticalExtensions | CHOICE { |
| c1 | CHOICE { |

```
      provideAssistanceData-r9 ProvideAssistanceData-r9-IEs,
      spare3 NULL, spare2 NULL, spare1 NULL
    },
```

| | |
|---|---|
| criticalExtensionsFuture | SEQUENCE { } |

}
}
ProvideAssistanceData-r9-IEs ::= SEQUENCE {

| | |
|---|---|
| commonIEsProvideAssistanceData | CommonIEsProvideAssistanceData |

OPTIONAL, -- Need ON

| | | |
|---|---|---|
| a-gnss-ProvideAssistanceData | A-GNSS-ProvideAssistanceData | OPTIONAL, - |

- Need ON

| | |
|---|---|
| otdoa-ProvideAssistanceData | OTDOA-ProvideAssistanceData |

OPTIONAL, -- Need ON

| | | |
|---|---|---|
| epdu-Provide-Assistance-Data | EPDU-Sequence | OPTIONAL, - |

```
- Need ON
  ...,
  [[
```

| | |
|---|---|
| sensor-ProvideAssistanceData-r14 | Sensor-ProvideAssistanceData-r14 |

OPTIONAL, -- Need ON

| | |
|---|---|
| tbs-ProvideAssistanceData-r14 | TBS-ProvideAssistanceData-r14 |

OPTIONAL, -- Need ON

| | |
|---|---|
| wlan-ProvideAssistanceData-r14 | WLAN-ProvideAssistanceData-r14 |

```
  OPTIONAL -- Need ON
  ]],
  [[ nr-Multi-RTT-ProvideAssistanceData-r16
```

NR-Multi-RTT-ProvideAssistanceData-r16

OPTIONAL, -- Need

ON
nr-DL-AoD-ProvideAssistanceData-r16

NR-DL-AoD-ProvideAssistanceData-r16OPTIONAL, -

- Need ON
nr-DL-TDOA-ProvideAssistanceData-r16

NR-DL-TDOA-ProvideAssistanceData-r16

OPTIONAL -- Need

```
ON
  ]],
  [[
    integritySupport-ProvideAssistanceData-r17 IntegritySupport-
```

| | |
|---|---|
| ProvideAssistanceData-r17 | OPTIONAL |

]]
}
-- ASN1STOP

In some embodiments, an IE can be defined for Integrity Support.

IntegritySupportProvideAssistanceData

The IE IntegritySupportProvideAssistanceData is used by the location server to provide assistance data to enable UE assisted NR Multi-RTT. It can also be used to provide NR Multi-RTT positioning specific error reason. In this example, High, Medium and Low thresholds have been provided, but the network may select only one threshold and not categorize.

-- ASN1START
integritySupportProvideAssistanceData-r16 ::= SEQUENCE {

| | | |
|---|---|---|
| al-RTD-HighThreshold-r17 | INTEGER (0..1966079) | OPTIONAL, |
| al-RTD-MediumThreshold-r17 | INTEGER (0..1966079) | OPTIONAL, |
| al-RTD-LowThreshold-r17 | INTEGER (0..1966079) | OPTIONAL |
| al-RSRP-HighThreshold-r17 | INTEGER (0..97) | OPTIONAL, |
| al-RSRP-HighThreshold-r17 | INTEGER (0..97) | OPTIONAL, |
| al-RSRP-HighThreshold-r17 | INTEGER (0..97) | OPTIONAL, |
| al-RSRP-HighThreshold-r17 | INTEGER (0..97) | OPTIONAL, |
| al-EexpectedRSTD-HighThreshold-r17 | INTEGER (−3841..3841), | OPTIONAL, |

```
  al-ExpectedRSTD-unceraintyHighThreshold-r17 INTEGER (−246..246),
  OPTIONAL,
```

| | |
|---|---|
| alertTimeHigh-r17 | INTEGER (0..FFS) OPTIONAL |
| alertTimeMedium-r17 | INTEGER (0..FFS) OPTIONAL, |
| alertTimeLow-r17 | INTEGER (0..FFS) OPTIOANL, |

...
}
-- ASN1STOP

As discussed, in some embodiments there are three example integrity parameters which can be set either by the network or the target device: Alert Limit, Integrity Risk, Protection Level.

The Alert Limit (AL) can be set for each application or use case. Therefore, it can be known by either the location server or the UE or by both, and it can be also shared from one to another by request. The network node can request for device integrity capabilities to understand whether the device is capable of processing the assistance information in this respect. Moreover, the type of UE can help the network to assess the AL for that particular device.

AL is the largest error allowable for safe operation. The AL can be configured in accordance with one or more of the following items:
Type of the device, and potentially known use-case
Bandwidth and carrier frequency
Indoor or outdoor classification of the device
3D map information
Speed, acceleration, or other sensor information from the device
Etc.

The AL can be reported to the device as an assistance data either automatically, when the device responds that it has integrity capability, or by a direct request from the device. A device may have the capability to set the AL by itself as well. In this case the device can report to the network on what AL it has assumed.

The positioning Integrity Risk (IR) is set by the location server and can be provided to the UE as an assistance information. The IR is the maximum probability of providing a signal that is out of tolerance without warning the user in a given period of time. The network node can set this parameter either for the complete set of OTDOA assistance data or for each separate positioning reference signal (PRS) of the suggested reference and neighbor cells separately.

The network node can configure the IR in accordance with one or more of the following parameters:
Clock drift of each network node
Synchronization error of each network node
Device type
Bandwidth and carrier frequency
Indoor or outdoor classification of the device
Serving cell or serving beam
3D map information
Speed, acceleration, or other sensor information from the device
Previous UE experiences on the IR with the similar condition
Expected RSTD, RSTD search window
Co-ordinate of cell boundary or center co-ordinate of cell and radius of the cell (the cell can be serving and/or neighbor reference cell)
Etc.

The IR can be given either as an overall percentage value or a percentage value for each separate PRS of cells/beams as the OTDOA assistance information.

In some embodiments, the network node can send the AL and IR in one signal. In other embodiments, the network node can only send the IR to the device considering that the AL is assumed by the device.

The device with the OTDOA (also referred to as DL-TDOA in NR) assistance information starts performing measurements and it can be so that the selection of the cells for OTDOA measurement would be identified based on monitoring the IRs. Further, the Protection Level (PL) can be computed at the device based on the IR received from the network node. PL is the statistical error bound computed to guarantee that the probability of the absolute position error exceeding the said number is smaller than or equal to the target integrity risk. The device reports this to the network node in the location information reporting together with the computed position estimation or the RSTD measurements in the case of UE-assisted OTDOA positioning.

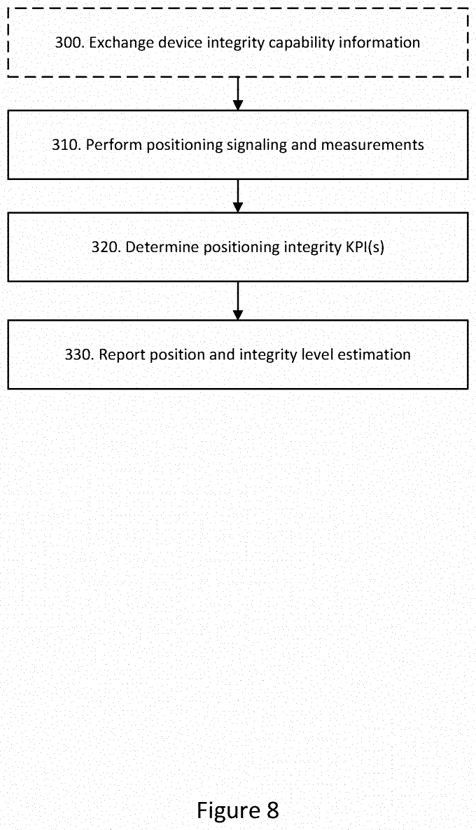

FIG. 8 is a flow chart illustrating a method which can be performed in a positioning node 200/202 as described herein. Positioning node 200/202 can be any of UE 100, access node 120 or location server 130. The method can include:

Step 300: Optionally, the positioning node can exchange device integrity capability information with the network (e.g. a second node). This can include receiving a device integrity capability request message from the network and transmitting a device integrity capability response message to the network. Various messages and/or parameters (e.g. IEs) can be used to communicate device capability in terms of supporting integrity.

Step 310: The positioning node performs positioning measurements to determine its estimated position. In some embodiments, the positioning node can monitor the integrity parameters (e.g. AL and/or IR) while obtaining the positioning measurements.

Step 320: The positioning node determines positioning Integrity KPI(s). One or more Integrity KPI and associated thresholds, integrity levels, etc. can be configured/defined in accordance with static, semi-static and/or dynamic factors as have been described herein. The Integrity KPI(s) may further be dependent on the node and/or network capabilities. In some embodiments, the Integrity KPI(s) can be initially configured prior to performing positioning measurements (in step 310) and can be monitored and/or adjusted as the node performs the measurements. The positioning node can calculate an estimated Integrity KPI/integrity level associated with its estimated position.

Step 330: The positioning node transmits a positioning information report to the network. This can include the estimated position and/or the estimated integrity level. The positioning information can include further information related to integrity, uncertainty and/or quality of the measurements.

It will be appreciated that in some embodiments, the positioning node can communicate (e.g. transmit/receive messages) directly with a second network node such as location server 130. In other embodiments, messages and signals between the entities may be communicated via other nodes, such as radio access node(s) (e.g. gNB, eNB) 120.

It will be appreciated that one or more of the above steps can be performed simultaneously and/or in a different order. Also, steps illustrated in dashed lines are optional and can be omitted in some embodiments.

FIG. 9 is a flow chart illustrating a method which can be performed in a network node, such as a gNB 120 and/or a location server 130 as described herein. The method can include:

Step 400: The network node obtains a QoS associated with a positioning application.

Step 410: The network node determines at least one integrity KPI associated with the QoS. The integrity KPI(s) can be determined in accordance with one or more of the static, semi-static and/or dynamic attributes as described herein. Non-limiting examples include: a positioning method to be used, the QoS for the positioning application, positioning measurements, and/or a capability associated with the wireless device.

The integrity KPI(s) can include one or more of: a threshold parameter per QoS, an estimated integrity level, an achieved integrity level, a positioning measurement configuration to achieve a target integrity level, and/or a fault flag or recommendations for operation.

In some embodiments, the integrity KPI(s) can include an IR parameter, the IR parameter indicating a maximum probability of providing a positioning service that is out of a tolerance range.

In some embodiments, the integrity KPI(s) can include an AL parameter, the AL parameter indicating a largest error allowable for safe operation.

In some embodiments, the integrity KPI(s) can include RTD and/or RSRP and/or RSTD threshold value(s).

Step 420: The network node transmits, to a wireless device, the at least one integrity KPI associated with the QoS. In some embodiments, the integrity KPI associated with the QoS can be included in transmitting positioning assistance information.

In some embodiments, the network node can receive, from the wireless device, an estimated position. The network node can further receive at least one of: an integrity level associated with the estimated position and/or a second integrity KPI. The network node can determine an integrity of the estimated position in accordance with the received integrity level and/or second integrity KPI.

It will be appreciated that in some embodiments, the network node can communicate (e.g. transmit/receive messages) directly with a target wireless device 110. In other embodiments, messages and signals between the entities may be communicated via other nodes, such as radio access node (e.g. gNB, eNB) 120.

It will be appreciated that one or more of the above steps can be performed simultaneously and/or in a different order. Also, steps illustrated in dashed lines are optional and can be omitted in some embodiments.

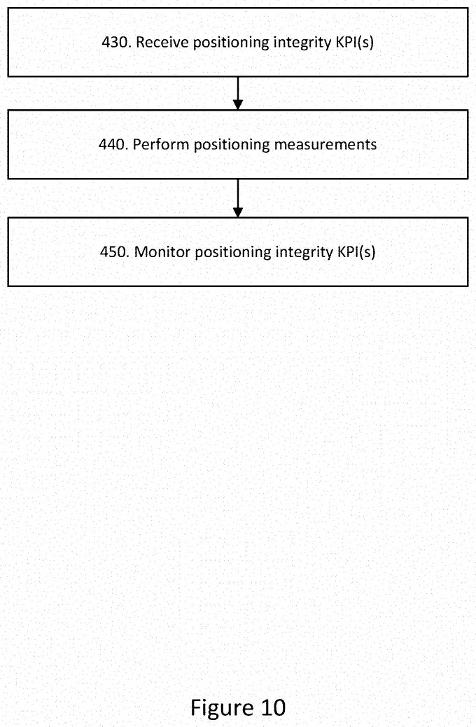

FIG. 10 is a flow chart illustrating a method which can be performed in a wireless device, such as a UE 110 as described herein. The method can include:

Step 430: The wireless device receives, from a network node, at least one integrity KPI associated with a QoS. The integrity KPI(s) can be included in positioning assistance information.

In some embodiments, the wireless device can determine a positioning method to use for performing positioning measurements in accordance with the received integrity KPI(s).

In some embodiments, the wireless device can determine one or more cells to use for performing positioning measurements in accordance with the received integrity KPI(s).

Step 440: The wireless device performs positioning measurements to determine an estimated position of the wireless device.

Step 450: The wireless device monitors the integrity KPI(s) while performing the positioning measurements.

In some embodiments, the wireless device can determine an integrity level associated with the estimated position of the wireless device.

In some embodiments, the wireless device can determine a second integrity KPI based at least in part on the received integrity KPI associated with the QoS. In some embodiments, this can include a PL parameter, the PL parameter indicating a statistical error bound computed to guarantee that probability of a position error exceeding the PL is less than or equal to the integrity KPI associated with the QoS.

In some embodiments, the wireless device can transmit the estimated position of the wireless device. The wireless device can further transmit an integrity level associated with the estimated position and/or and the second integrity KPI.

It will be appreciated that in some embodiments, the wireless device can communicate (e.g. transmit/receive messages) directly with a network node such as location server 130. In other embodiments, messages and signals between the entities may be communicated via other nodes, such as radio access node (e.g. gNB, eNB) 120.

It will be appreciated that one or more of the above steps can be performed simultaneously and/or in a different order. Also, steps illustrated in dashed lines are optional and can be omitted in some embodiments.

FIG. 11 is a block diagram of an example wireless device, UE 110, in accordance with certain embodiments. UE 110 includes a transceiver 510, processor 520, and memory 530. In some embodiments, the transceiver 510 facilitates transmitting wireless signals to and receiving wireless signals from radio access node 120 (e.g., via transmitter(s) (Tx), receiver(s) (Rx) and antenna(s)). The processor 520 executes instructions to provide some or all of the functionalities described above as being provided by UE, and the memory 530 stores the instructions executed by the processor 520. In some embodiments, the processor 520 and the memory 530 form processing circuitry.

The processor 520 can include any suitable combination of hardware to execute instructions and manipulate data to perform some or all of the described functions of a wireless device, such as the functions of UE 110 described above. In some embodiments, the processor 520 may include, for example, one or more computers, one or more central processing units (CPUs), one or more microprocessors, one or more application specific integrated circuits (ASICs), one or more field programmable gate arrays (FPGAs) and/or other logic.

The memory 530 is generally operable to store instructions, such as a computer program, software, an application including one or more of logic, rules, algorithms, code, tables, etc. and/or other instructions capable of being executed by a processor 520. Examples of memory 530 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information, data, and/or instructions that may be used by the processor 520 of UE 110.

Other embodiments of UE 110 may include additional components beyond those shown in FIG. 11 that may be responsible for providing certain aspects of the wireless device's functionalities, including any of the functionalities described above and/or any additional functionalities (including any functionality necessary to support the solution described above). As just one example, UE 110 may include input devices and circuits, output devices, and one or more synchronization units or circuits, which may be part of the processor 520. Input devices include mechanisms for entry of data into UE 110. For example, input devices may include input mechanisms, such as a microphone, input elements, a display, etc. Output devices may include mechanisms for outputting data in audio, video and/or hard copy format. For example, output devices may include a speaker, a display, etc.

In some embodiments, the wireless device UE 110 may comprise a series of modules configured to implement the functionalities of the wireless device described above. Referring to FIG. 12, in some embodiments, the wireless device 110 may comprise a control module 550 for receiving and interpreting control/configuration/capability information, a positioning module 560 for performing positioning measurements and calculating an estimated position, and an integrity module 570 for monitoring and determining the integrity associated with the positioning measurements.

It will be appreciated that the various modules may be implemented as combination of hardware and software, for instance, the processor, memory and transceiver(s) of UE 110 shown in FIG. 11. Some embodiments may also include additional modules to support additional and/or optional functionalities.

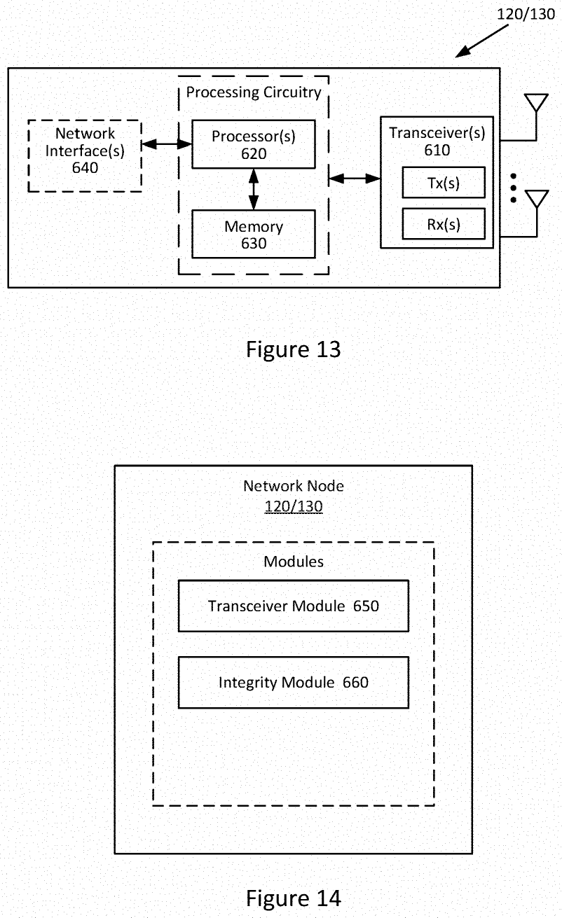

FIG. 13 is a block diagram of an exemplary network node 120/130. The exemplary node can be a location server 130 or an access node 120, in accordance with certain embodiments. Network node 120/130 may include one or more of a transceiver 610, processor 620, memory 630, and network interface 640. In some embodiments, the transceiver 610 facilitates transmitting wireless signals to and receiving wireless signals from wireless devices, such as UE 110 (e.g., via transmitter(s) (Tx), receiver(s) (Rx), and antenna(s)). The processor 620 executes instructions to provide some or all of the functionalities described above as being provided by network node 120/130, the memory 630 stores the instructions executed by the processor 620. In some embodiments, the processor 620 and the memory 630 form processing circuitry. The network interface 640 can communicate signals to backend network components, such as a gateway, switch, router, Internet, Public Switched Telephone Network (PSTN), core network nodes or radio network controllers, etc.

The processor 620 can include any suitable combination of hardware to execute instructions and manipulate data to perform some or all of the described functions of network node 120/130, such as those described above. In some embodiments, the processor 620 may include, for example, one or more computers, one or more central processing units (CPUs), one or more microprocessors, one or more application specific integrated circuits (ASICs), one or more field programmable gate arrays (FPGAs) and/or other logic.

The memory 630 is generally operable to store instructions, such as a computer program, software, an application including one or more of logic, rules, algorithms, code, tables, etc. and/or other instructions capable of being executed by a processor 620. Examples of memory 630 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, the network interface 640 is communicatively coupled to the processor 620 and may refer to any suitable device operable to receive input for node 120/130, send output from node 120/130, perform suitable processing of the input or output or both, communicate to other devices, or any combination of the preceding. The network interface 640 may include appropriate hardware (e.g., port, modem, network interface card, etc.) and software, including protocol conversion and data processing capabilities, to communicate through a network.

Other embodiments of network node 120/130 can include additional components beyond those shown in FIG. 13 that may be responsible for providing certain aspects of the node's functionalities, including any of the functionalities described above and/or any additional functionalities (including any functionality necessary to support the solutions described above). The various different types of network nodes may include components having the same physical hardware but configured (e.g., via programming) to support different radio access technologies, or may represent partly or entirely different physical components.

Processors, interfaces, and memory similar to those described with respect to FIG. 13 may be included in other network nodes (such as UE 110, radio access node 120, etc.). Other network nodes may optionally include or not include a wireless interface (such as the transceiver described in FIG. 13).

In some embodiments, the network node 120/130, may comprise a series of modules configured to implement the functionalities of the network node described above. Referring to FIG. 14, in some embodiments, the network node 120/130 can comprise a transceiver module 650 for transmitting and receiving positioning-related messages, such as capability requests/responses, positioning information and reports, and an integrity module 660 for determining integrity-related parameter(s) associated with a device and for determining the integrity associated with an estimated position of the device.

It will be appreciated that the various modules may be implemented as combination of hardware and software, for instance, the processor, memory and transceiver(s) of network node 120/130 shown in FIG. 13. Some embodiments may also include additional modules to support additional and/or optional functionalities.

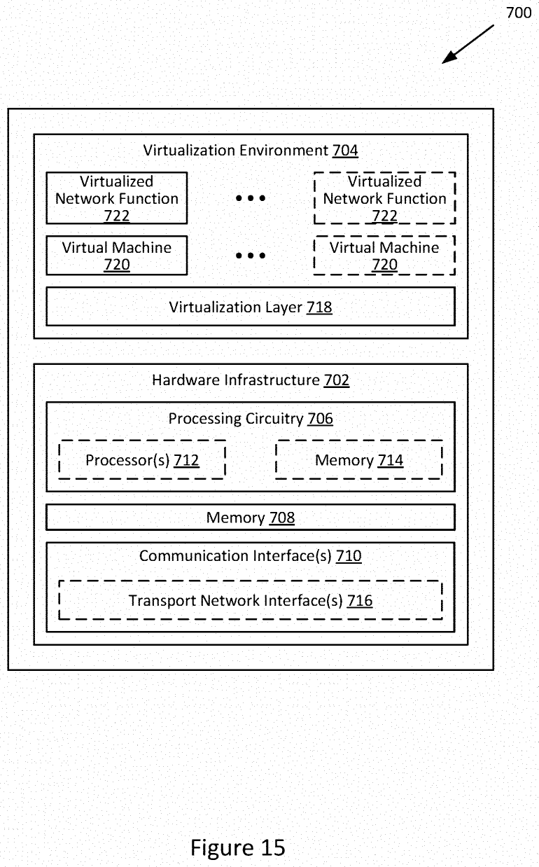

Turning now to FIG. 15, some network nodes (e.g. UEs 110, radio access nodes 120, core network nodes 130, etc.) in the wireless communication network 100 may be partially or even entirely virtualized. As a virtualized entity, some or all the functions of a given network node are implemented as one or more virtual network functions (VNFs) running in virtual machines (VMs) hosted on a typically generic processing node 700 (or server).

Processing node 700 generally comprises a hardware infrastructure 702 supporting a virtualization environment 704.

The hardware infrastructure 702 generally comprises processing circuitry 706, a memory 708, and communication interface(s) 710.

Processing circuitry 706 typically provides overall control of the hardware infrastructure 702 of the virtualized processing node 700. Hence, processing circuitry 706 is generally responsible for the various functions of the hardware infrastructure 702 either directly or indirectly via one or more other components of the processing node 700 (e.g. sending or receiving messages via the communication interface 710). The processing circuitry 706 is also responsible for enabling, supporting and managing the virtualization environment 704 in which the various VNFs are run. The processing circuitry 706 may include any suitable combination of hardware to enable the hardware infrastructure 702 of the virtualized processing node 700 to perform its functions.

In some embodiments, the processing circuitry 706 may comprise at least one processor 712 and at least one memory 714. Examples of processor 712 include, but are not limited to, a central processing unit (CPU), a graphical processing unit (GPU), and other forms of processing unit. Examples of memory 714 include, but are not limited to, Random Access Memory (RAM) and Read Only Memory (ROM). When processing circuitry 706 comprises memory 714, memory 714 is generally configured to store instructions or codes executable by processor 712, and possibly operational data. Processor 712 is then configured to execute the stored instructions and possibly create, transform, or otherwise manipulate data to enable the hardware infrastructure 702 of the virtualized processing node 700 to perform its functions.

Additionally, or alternatively, in some embodiments, the processing circuitry 706 may comprise, or further comprise, one or more application-specific integrated circuits (ASICs), one or more complex programmable logic device (CPLDs), one or more field-programmable gate arrays (FPGAs), or other forms of application-specific and/or programmable circuitry. When the processing circuitry 706 comprises application-specific and/or programmable circuitry (e.g., ASICs, FPGAs), the hardware infrastructure 702 of the virtualized processing node 700 may perform its functions without the need for instructions or codes as the necessary instructions may already be hardwired or preprogrammed into processing circuitry 706. Understandably, processing circuitry 706 may comprise a combination of processor(s) 712, memory(ies) 714, and other application-specific and/or programmable circuitry.

The communication interface(s) 710 enable the virtualized processing node 700 to send messages to and receive messages from other network nodes (e.g., radio network nodes, other core network nodes, servers, etc.). In that sense, the communication interface 710 generally comprises the necessary hardware and software to process messages received from the processing circuitry 706 to be sent by the virtualized processing node 700 into a format appropriate for the underlying transport network and, conversely, to process messages received from other network nodes over the underlying transport network into a format appropriate for the processing circuitry 706. Hence, communication interface 710 may comprise appropriate hardware, such as transport network interface(s) 716 (e.g., port, modem, network interface card, etc.), and software, including protocol conversion and data processing capabilities, to communicate with other network nodes.

The virtualization environment 704 is enabled by instructions or codes stored on memory 708 and/or memory 714. The virtualization environment 704 generally comprises a virtualization layer 718 (also referred to as a hypervisor), at least one virtual machine 720, and at least one VNF 722. The functions of the processing node 700 may be implemented by one or more VNFs 722.

Some embodiments may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause processing circuitry (e.g. a processor) to perform steps in a method according to one or more embodiments. Those of ordinary skill in the art will appreciate that other instructions and operations necessary to implement the described embodiments may also be stored on the machine-readable medium. Software running from the machine-readable medium may interface with circuitry to perform the described tasks.

The above-described embodiments are intended to be examples only. Alterations, modifications and variations may be effected to the particular embodiments by those of skill in the art without departing from the scope of the description.

### Glossary

The present description may comprise one or more of the following abbreviation:

3GPP Third Generation Partnership Project

ACK Acknowledgement

AP Access point

ARQ Automatic Repeat Request

BS Base Station

BSC Base station controller

BSR Buffer Status Report

BTS Base transceiver station

CA Carrier Aggregation

CC Component carrier

CCCH SDU Common Control Channel SDU

CG Configured Grant

CGI Cell Global Identifier

CN Core network

CQI Channel Quality information

CSI Channel State Information

CU Central Unit

DAS Distributed antenna system

DC Dual connectivity

DCCH Dedicated Control Channel

DCI Downlink Control Information

DL Downlink

DMRS Demodulation Reference Signal

DU Distributed Unit

eMBB Enhanced Mobile Broadband

eNB E-UTRAN NodeB or evolved NodeB

ePDCCH enhanced Physical Downlink Control Channel

E-SMLC evolved Serving Mobile Location Center

E-UTRA Evolved UTRA

E-UTRAN Evolved UTRAN

FDM Frequency Division Multiplexing

HARQ Hybrid Automatic Repeat Request

HO Handover

IAB Integrated Access Backhaul

IoT Internet of Things

LCH Logical channel

LTE Long-Term Evolution

M2M Machine to Machine

MAC Medium Access Control

MBMS Multimedia Broadcast Multicast Services

MCG Master cell group

MDT Minimization of Drive Tests

MeNB Master eNode B

MME Mobility Management Entity

MSC Mobile Switching Center

MSR Multi-standard Radio

MTC Machine Type Communication

NACK Negative acknowledgement

NDI Next Data Indicator

NR New Radio

O&M Operation and Maintenance

OFDM Orthogonal Frequency Division Multiplexing

OFDMA Orthogonal Frequency Division Multiple Access

OSS Operations Support System

PCC Primary Component Carrier

P-CCPCH Primary Common Control Physical Channel

PCell Primary Cell

PCG Primary Cell Group

PCH Paging Channel

PCI Physical Cell Identity

PDCCH Physical Downlink Control Channel

PDCP Packet Data Convergence Protocol

PDSCH Physical Downlink Shared Channel

PDU Protocol Data Unit

PGW Packet Gateway

PHICH Physical HARQ indication channel

PMI Precoder Matrix Indicator

ProSe Proximity Service

PSC Primary serving cell

PSCell Primary SCell

PUCCH Physical Uplink Control Channel

PUSCH Physical Uplink Shared Channel

RAT Radio Access Technology

RB Resource Block

RF Radio Frequency

RLC Radio Link Control

RLM Radio Link Management

RNC Radio Network Controller

RRC Radio Resource Control

RRH Remote Radio Head

RRM Radio Resource Management

RRU Remote Radio Unit

RSRP Reference Signal Received Power

RSRQ Reference Signal Received Quality

RSSI Received Signal Strength Indicator

RSTD Reference Signal Time Difference

RTT Round Trip Time

SCC Secondary Component Carrier

SCell Secondary Cell

SCG Secondary Cell Group

SCH Synchronization Channel

SDU Service Data Unit

SeNB Secondary eNodeB

SGW Serving Gateway

SI System Information

SIB System Information Block

SINR Signal to Interference and Noise Ratio

SNR Signal Noise Ratio

SPS Semi-persistent Scheduling

SON Self-organizing Network

SR Scheduling Request

SRS Sounding Reference Signal

SSC Secondary Serving Cell

TB Transport Block

TTI Transmission Time Interval

Tx Transmitter

UE User Equipment

UL Uplink

URLLC Ultra-Reliable Low Latency Communication

UTRA Universal Terrestrial Radio Access

UTRAN Universal Terrestrial Radio Access Network

V2V Vehicle-to-vehicle

V2X Vehicle-to-everything

WLAN Wireless Local Area Network

1. A method performed by a network node, the method comprising:
obtaining a quality of service (QoS) for a positioning application;
determining an integrity key performance indicator (KPI) associated with the QoS; and
transmitting, to a wireless device, the integrity KPI associated with the QoS.

2. The method of claim 1, wherein the integrity KPI associated with the QoS is included in positioning assistance information.

3. The method of any one of claims 1 to 2, wherein the integrity KPI associated with the QoS is determined based at least in part on one or more of: a positioning method to be used, the QoS for the positioning application, positioning measurements, and a capability associated with the wireless device.

4. The method of any one of claims 1 to 3, wherein the integrity KPI associated with the QoS includes one or more of: a threshold parameter per QoS, an estimated integrity level, an achieved integrity level, a positioning measurement configuration to achieve a target integrity level, and a fault flag or recommendations for operation.

5. The method of any one of claims 1 to 4, wherein the integrity KPI associated with the QoS includes an integrity risk (IR) parameter, the IR parameter indicating a maximum probability of providing a positioning service that is out of a tolerance range.

6. The method of any one of claims 1 to 5, wherein the integrity KPI associated with the QoS includes an alert limit (AL) parameter, the AL parameter indicating a largest error allowable for safe operation.

7. The method of any one of claims 1 to 6, wherein the integrity KPI associated with the QoS includes one or more Real Time Difference (RTD) threshold value or Reference Signal Received Power (RSRP) threshold value or Reference Signal Time Difference (RSTD) threshold value.

8. The method of any one of claims 1 to 7, further comprising, receiving, from the wireless device, an estimated position.

9. The method of claim 8, further comprising, receiving, from the wireless device at least one of: an integrity level associated with the estimated position, and a second integrity KPI.

10. The method of claim 9, further comprising, determining an integrity of the estimated position in accordance with the received second integrity KPI.

11. A network node comprising a radio interface and processing circuitry configured to:
obtain a quality of service (QoS) for a positioning application;
determine an integrity key performance indicator (KPI) associated with the QoS; and
transmit, to a wireless device, the integrity KPI associated with the QoS.

12. The network node of claim 11, wherein the integrity KPI associated with the QoS is included in positioning assistance information.

13. The network node of any one of claims 11 to 12, wherein the integrity KPI associated with the QoS is determined based at least in part on one or more of: a positioning method to be used, the QoS for the positioning application, positioning measurements, and a capability associated with the wireless device.

14. The network node of any one of claims 11 to 13, wherein the integrity KPI associated with the QoS includes one or more of: a threshold parameter per QoS, an estimated integrity level, an achieved integrity level, a positioning measurement configuration to achieve a target integrity level, and a fault flag or recommendations for operation.

15. The network node of any one of claims 11 to 14, wherein the integrity KPI associated with the QoS includes an integrity risk (IR) parameter, the IR parameter indicating a maximum probability of providing a positioning service that is out of a tolerance range.

16. The network node of any one of claims 11 to 15, wherein the integrity KPI associated with the QoS includes an alert limit (AL) parameter, the AL parameter indicating a largest error allowable for safe operation.

17. The network node of any one of claims 11 to 16, wherein the integrity KPI associated with the QoS includes one or more Real Time Difference (RTD) threshold value or Reference Signal Received Power (RSRP) threshold value or Reference Signal Time Difference (RSTD) threshold value.

18. The network node of any one of claims 11 to 17, further configured to receive, from the wireless device, an estimated position.

19. The network node of claim 18, further configured to receive, from the wireless device at least one of: an integrity level associated with the estimated position, and a second integrity KPI.

20. The network node of claim 19, further configured to determine an integrity of the estimated position in accordance with the received second integrity KPI.

21. A method performed by a wireless device, the method comprising:
receiving, from a network node, an integrity key performance indicator (KPI) associated with a quality of service (QoS);
performing positioning measurements to determine an estimated position of the wireless device; and
monitoring the integrity KPI associated with the QoS while performing the positioning measurements.

22. The method of claim 21, wherein the integrity KPI associated with the QoS is included in positioning assistance information.

23. The method of any one of claims 21 to 22, wherein the integrity KPI associated with the QoS includes one or more of: a threshold parameter per QoS, an estimated integrity level, an achieved integrity level, a positioning measurement configuration to achieve a target integrity level, and a fault flag or recommendations for operation.

24. The method of any one of claims 21 to 23, wherein the integrity KPI associated with the QoS includes an integrity risk (IR) parameter, the IR parameter indicating a maximum probability of providing a positioning service that is out of a tolerance range.

25. The method of any one of claims 21 to 24, wherein the integrity KPI associated with the QoS includes an alert limit (AL) parameter, the AL parameter indicating a largest error allowable for safe operation.

26. The method of any one of claims 21 to 25, wherein the integrity KPI associated with the QoS includes one or more Real Time Difference (RTD) threshold value or Reference Signal Received Power (RSRP) threshold value or Reference Signal Time Difference (RSTD) threshold value.

27. The method of any one of claims 21 to 26, further comprising, determining a positioning method to use for the positioning measurements in accordance with the received integrity KPI associated with the QoS.

28. The method of any one of claims 21 to 27, further comprising, determining one or more cells to use for the positioning measurements in accordance with the received integrity KPI associated with the QoS.

29. The method of any one of claims 21 to 28, further comprising, determining a second integrity KPI based at least in part on the received integrity KPI associated with the QoS.

30. The method of claim 29, wherein the second integrity KPI includes a Protection Level (PL) parameter, the PL parameter indicating a statistical error bound computed to guarantee that probability of a position error exceeding the PL is less than or equal to the integrity KPI associated with the QoS.

31. The method of any one of claims 21 to 30, further comprising, transmitting, to the network node, the estimated position of the wireless device.

32. The method of claim 31, further comprising, transmitting, to the network node, at least one of: an integrity level associated with the estimated position, and the second integrity KPI.

33. A wireless device comprising a radio interface and processing circuitry configured to:
receive, from a network node, an integrity key performance indicator (KPI) associated with a quality of service (QoS);
perform positioning measurements to determine an estimated position of the wireless device; and
monitor the integrity KPI associated with the QoS while performing the positioning measurements.

34. The wireless device of claim 33, wherein the integrity KPI associated with the QoS is included in positioning assistance information.

35. The wireless device of any one of claims 33 to 34, wherein the integrity KPI associated with the QoS includes one or more of: a threshold parameter per QoS, an estimated integrity level, an achieved integrity level, a positioning measurement configuration to achieve a target integrity level, and a fault flag or recommendations for operation.

36. The wireless device of any one of claims 33 to 35, wherein the integrity KPI associated with the QoS includes an integrity risk (IR) parameter, the IR parameter indicating a maximum probability of providing a positioning service that is out of a tolerance range.

37. The wireless device of any one of claims 33 to 36, wherein the integrity KPI associated with the QoS includes an alert limit (AL) parameter, the AL parameter indicating a largest error allowable for safe operation.

38. The wireless device of any one of claims 33 to 37, wherein the integrity KPI associated with the QoS includes one or more Real Time Difference (RTD) threshold value or Reference Signal Received Power (RSRP) threshold value or Reference Signal Time Difference (RSTD) threshold value.

39. The wireless device of any one of claims 33 to 38, further comprising, determining a positioning method to use for the positioning measurements in accordance with the received integrity KPI associated with the QoS.

40. The wireless device of any one of claims 33 to 39, further comprising, determining one or more cells to use for the positioning measurements in accordance with the received integrity KPI associated with the QoS.

41. The wireless device of any one of claims 33 to 40, further comprising, determining a second integrity KPI based at least in part on the received integrity KPI associated with the QoS.

42. The wireless device of claim 41, wherein the second integrity KPI includes a Protection Level (PL) parameter, the PL parameter indicating a statistical error bound computed to guarantee that probability of a position error exceeding the PL is less than or equal to the integrity KPI associated with the QoS.

43. The wireless device of any one of claims 33 to 42, further comprising, transmitting, to the network node, the estimated position of the wireless device.

44. The wireless device of claim 43, further comprising, transmitting, to the network node, at least one of: an integrity level associated with the estimated position, and the second integrity KPI.
